(19) United States
(12) Patent Application Publication
(10) Pub. No.: US 2013/0181905 A1
(43) Pub. Date: Jul. 18, 2013

(54) APPARATUS AND METHOD FOR MANAGING INSTANT MESSAGING

(71) Applicant: PO-CHING CHIANG, New Taipei (TW)

(72) Inventor: PO-CHING CHIANG, New Taipei (TW)

(73) Assignee: HON HAI PRECISION INDUSTRY CO., LTD., New Taipei (TW)

(21) Appl. No.: 13/670,541

(22) Filed: Nov. 7, 2012

(30) Foreign Application Priority Data
Jan. 13, 2012 (TW) 101101324

(51) Int. Cl. G06F 3/041; G06F 3/02

(52) U.S. Cl. 345/168

(57) ABSTRACT

An electronic device includes a touch screen, a virtual keyboard projector, and a content projector. When a first touch gesture is detected by the touch screen, the virtual keyboard projector produces a projected virtual keyboard. An input content is obtained through the projected virtual keyboard and transmitted to a remote electronic device through a communication interface. The electronic device receives a messaging content from the remote electronic device. When a second touch gesture is detected by the touch screen, the content projector projects a projected display and presents the messaging content in the projected display. A method of managing instant messaging in the electronic device is also provided.

### REFERENCE TO RELATED APPLICATIONS

This application claims all benefits accruing under 35 U.S.C. §119 from Taiwan Patent Application No. 101101324, filed on Jan. 13, 2012 in the Taiwan Intellectual Property Office. The contents of the Taiwan Application are hereby incorporated by reference.

### BACKGROUND

1. Technical Field

The disclosure generally relates to digital communication systems, and particularly relates to apparatuses and methods for managing instant messaging.

2. Description of Related Art

Smartphones are becoming more popular because of their more advanced computing capability and connectivity than feature phones. Modern smartphones often have Internet access capability, which allows users use a large number of Internet-based software applications on the smartphones. One of the most frequently used applications is instant messaging. However, the users can only view instant messages in a narrow and small display since the display screen of smartphones is limited in size.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an electronic device that may be employed to implement an instant messaging system in accordance with one embodiment.

FIG. 2 shows the electronic device of FIG. 1 viewed from various aspects.

FIG. 3 is a flowchart showing one embodiment of a method of managing instant messaging in the electronic device of FIG. 1.

FIG. 4 shows the electronic device of FIG. 1 projecting a virtual keyboard projected.

FIG. 5 shows the electronic device of FIG. 4 projecting a left display.

FIG. 6 shows the electronic device of FIG. 5 projecting a right display.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

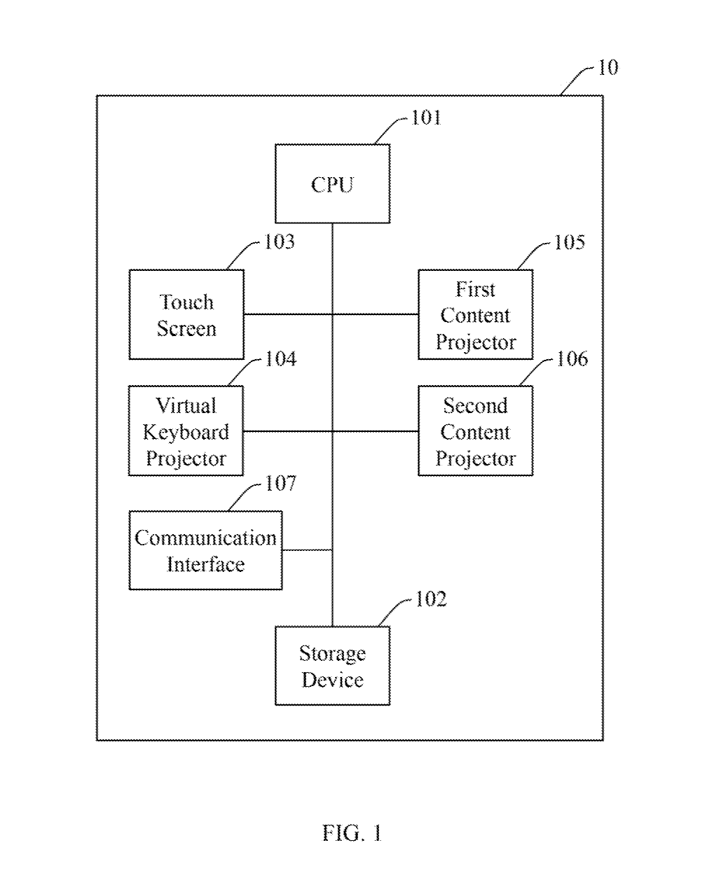

FIG. 1 shows an electronic device 10 that may be employed to implement an instant messaging system in accordance with one embodiment. The electronic device 10 includes a central processing unit (CPU) 101, a storage device 102, a touch screen 103, a virtual keyboard projector 104, a first content projector 105, a second content projector 106, and a communication interface 107. The electronic device 10 may be a smartphone, a personal digital assistant (PDA), or a tablet computer.

The CPU 101 is operably coupled to the storage device 102, the touch screen 103, the virtual keyboard projector 104, the first content projector 105, the second content projector 106, and the communication interface 107. The CPU 101 may include one or more processors that provide the processing capability to execute the operating system, programs, user and application interfaces, and any other functions of the electronic device 10. The CPU 101 may include one or more microprocessors and/or related chip sets. For example, the CPU 101 may include “general purpose” microprocessors, a combination of general and special purpose microprocessors, instruction set processors, graphics processors, video processors, related chips sets, and/or special purpose microprocessors. The CPU 101 also may include on board memory for caching purposes.

Information, such as programs and/or instructions, used by the CPU 101 may be located within the storage device 102. The storage device 102 may store a variety of information and may be used for various purposes. For example, the storage device 102 may store firmware for the electronic device 10 (such as a basic input/output instruction or operating system instructions), various programs, applications, or routines executed on the electronic device 10, user interface functions, processor functions, and so forth. According to certain embodiments, the storage device 102 may store a program enabling establishment of an instant messaging system using electronic device 10. In addition, the storage device 102 may be used for buffering or caching during operation of the electronic device 10.

The storage device 102 may include any suitable manufacture that includes one or more tangible, computer-readable media. For example, the storage device 102 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The touch screen 103 may display a graphic user interface (GUI) that enables a user to interact with an instant messaging system. The touch screen 103 may detect touch gestures made by the user on the touch screen 103.

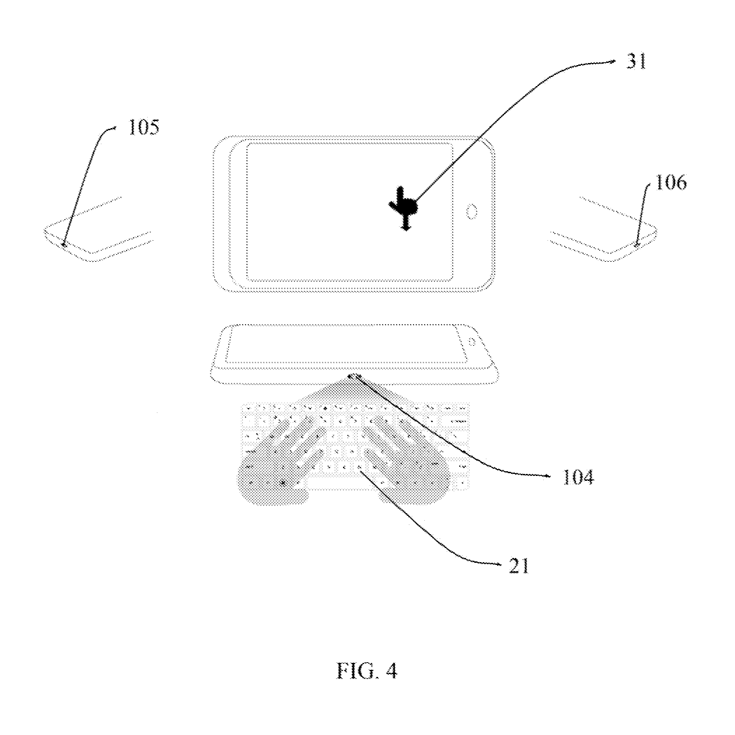

The virtual keyboard projector 104 may produce a projected virtual keyboard 21 as shown in FIG. 4. The virtual keyboard projector 104 may include a camera or other means for detecting gestures made with the projected virtual keyboard 21. The virtual keyboard projector 104 may obtain input contents according to the detected gestures made with the projected virtual keyboard 21. In some embodiments, the virtual keyboard projector 104 may send the detected gestures made with the projected virtual keyboard 21 and the CPU 101 obtains input contents according the detected gestures made with the projected virtual keyboard 21.

The first content projector 105 and the second content projector 106 may produce projected displays and present desired contents in the projected displays.

The communication interface 107 may provide connectivity channels for receiving and transmitting information and/or for connecting to other electronic devices. The communication interface 107 may represent, for example, a network interface card (NIC) or a network controller. The communication interface 107 may include a local area network (LAN) interface for connecting to a wired Ethernet-based network and/or a wireless LAN, such as an IEEE 802.11x wireless network.

The communication interface 107 also may include a wide area network (WAN) interface that permits connection to the Internet via a cellular data network, such as the Enhanced Data rates for GMS Evolution (EDGE) network or a 3G or 4G network. Further, the communication interface 107 may include a personal area network (PAN) interface for connecting to a BLUETOOTH® network, an IEE 802.15.4 (Zig-Bee) network, or an ultra-wideband network (UWB). The communication interface 107 may include any number and combination of network interfaces. As will be appreciated, the communication interface 107 may employ one or more protocols, such as the High-Speed Downlink Packet Access (HSDPA) protocol, for rapidly downloading data over a network. Additionally, the communication interface 107 may allow the electronic device 10 to receive a software upgrade that the enables electronic device 10 to establish and/or control an instant messaging system in accordance with certain embodiments.

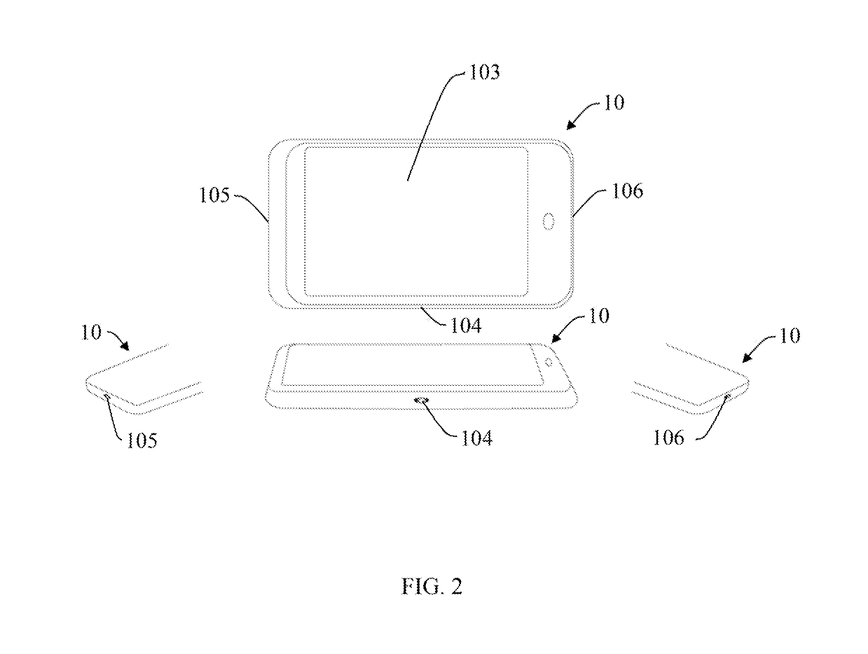

FIG. 2 shows the electronic device 10 viewed from various aspects. The virtual keyboard projector 104 is arranged in a lengthwise side of the electronic device 10. The first content projector 105 and the second content projector 106 are arranged in two opposite widthwise sides of the electronic device 10. For example, the first content projector 105 is arranged in the left widthwise side of the electronic device 10, and the second content projector 106 is arranged in the right widthwise side of the electronic device 10.

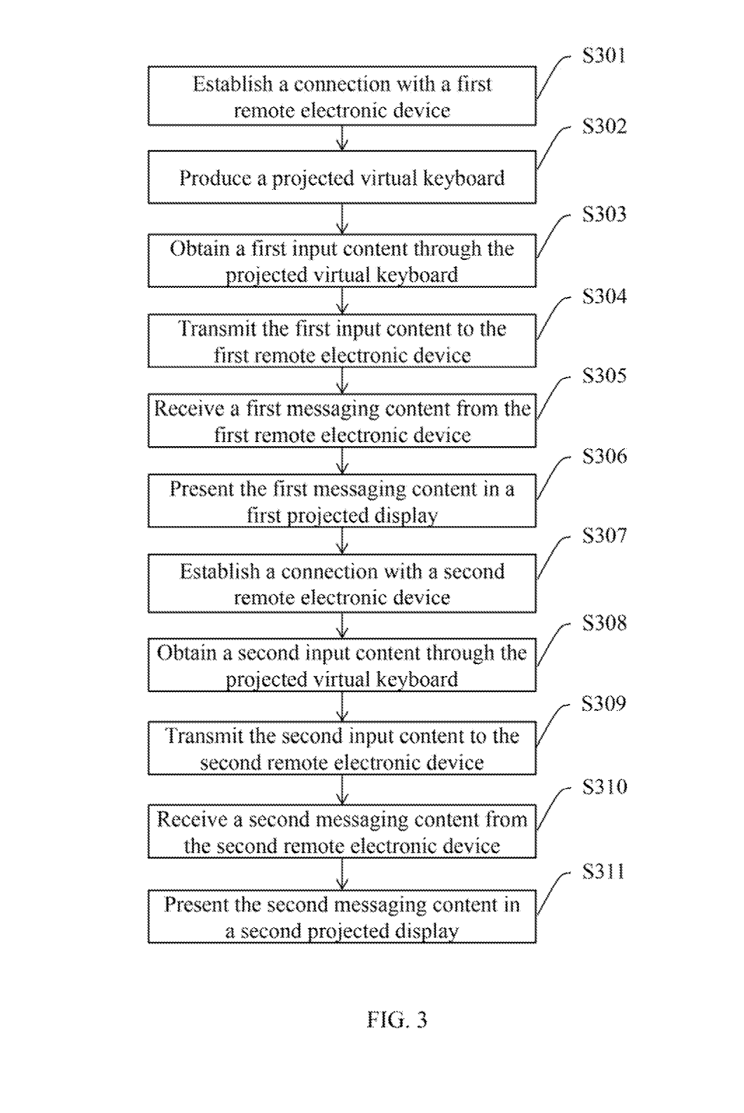

FIG. 3 is a flowchart showing one embodiment of a method for managing instant messaging in the electronic device 10. The method comprises the following steps.

In step S301, the communication interface 107 establishes a connection with a first remote electronic device.

In step S302, the touch screen 103 detects a first touch gesture 31. The virtual keyboard projector 104 produces a projected virtual keyboard 21 in response to the first touch gesture 31. Referring to FIG. 4, one example of the first touch gesture 31 is shown. The first touch gesture 31 includes a touch input that is moved along a substantially straight path having a direction towards the length side of the electronic device 10.

In step S303, the virtual keyboard projector 104 detects gestures made with the projected virtual keyboard 21. A first input content, such as a text, is obtained according to the detected gestures made with the projected virtual keyboard 21.

In step S304, the first input content is transmitted to the first remote electronic device through the communication interface 107.

In step S305, the electronic device 10 receives a first messaging content from the first remote electronic device through the communication interface 107.

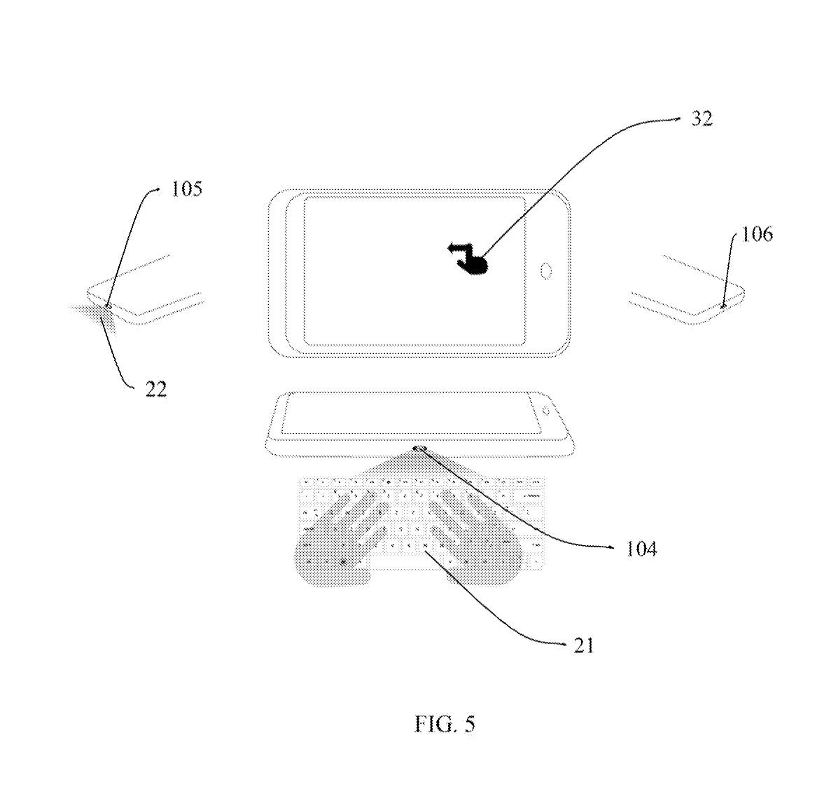

In step S306, the touch screen 103 detects a second touch gesture 32. The first content projector 105 produces a first projected display 22 and presents the first messaging content in the first projected display 22 in response to the second touch gesture 32. The first projected display 22 is projected on the left widthwise side of the electronic device 10. Referring to FIG. 5, one example of the second touch gesture 32 is shown. The second touch gesture 32 includes a touch input that is moved along a substantially straight path having a direction towards the left widthwise side of the electronic device 10.

In step S307, the communication interface 107 establishes a connection with a second remote electronic device.

In step S308, a second input content is obtained according to the detected gestures made with the projected virtual keyboard 21.

In step S309, the second input content is transmitted to the second remote electronic device through the communication interface 107.

In step S310, the electronic device 10 receives a second messaging content from the second remote electronic device through the communication interface 107.

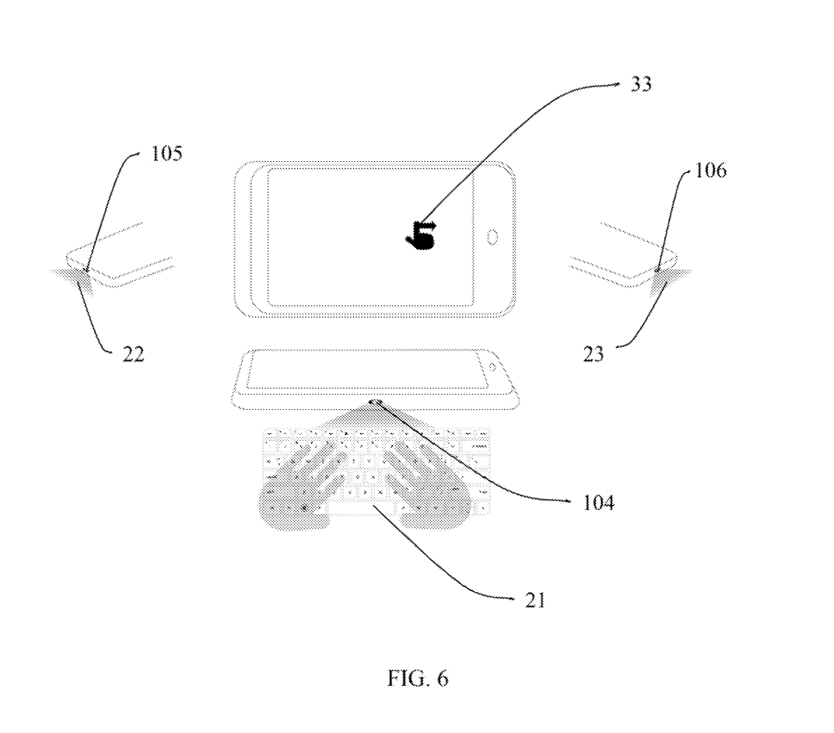

In step S311, the touch screen 103 detects a third touch gesture 33. The second content projector 103 produces a second projected display 23 and presents the second messaging content in the second projected display 23 in response to the third touch gesture 33. The second projected display 23 is projected on the right widthwise side of the electronic device 10. FIG. 6 shows one example of the third touch gesture 33. The third touch gesture 33 includes a touch input that is moved along a substantially straight path having a direction towards the right widthwise side of the electronic device 10.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a touch screen;
a virtual keyboard projector configured to produce a projected virtual keyboard in response to a first touch gesture detected by the touch screen;
a communication interface configured to enable communication with a first remote electronic device;
a first content projector; and
a processing unit operably coupled to the communication interface, the touch screen, the virtual keyboard projector, and the first content projector, the processing unit is configured to obtain a first input content through the projected virtual keyboard, to transmit the first input content to the first remote electronic device through the communication interface, and to receive a first messaging content from the first remote device through the communication interface;
wherein the first content projector is configured to produce a first projected display and present the first messaging content in the first projected display in response to a second touch gesture detected by the touch screen.

2. The electronic device of claim 1, wherein the communication interface is further configured to enable communication with a second remote electronic device, the processing unit is further adapted to obtain a second input content through the projected virtual keyboard, to transmit the second input content to the second remote electronic device through the communication interface, and to receive a second messaging content from the second remote device through the communication interface.

3. The electronic device of claim 2, wherein the electronic device further comprises a second content projector, the processing unit is operably coupled to the second content projector, the second content projector is configured to produce a second projected display and present the second messaging content in the second projected display in response to a third touch gesture detected by the touch screen.

4. The electronic device of claim 3, wherein the projected virtual keyboard, the first projected display, and the second projected display are projected on different sides of the electronic device.

5. The electronic device of claim 4, wherein the projected virtual keyboard is projected on a longwise side of the electronic device, the first projected display is projected on the first widthwise side of the electronic device, and the second projected display is projected on the second widthwise side of the electronic device.

6. The electronic device of claim 5, wherein the first widthwise side is opposite to the second widthwise side.

7. The electronic device of claim 6, wherein the first touch gesture comprises a touch input moving along a substantially straight path towards the length side of the electronic device.

8. The electronic device of claim 7, wherein the second touch gesture comprises a touch input moving along a substantially straight path towards the first widthwise side of the electronic device.

9. The electronic device of claim 8, wherein the third touch gesture comprises a touch input moving along a substantially straight path towards the second widthwise side of the electronic device.

10. The electronic device of claim 8, wherein the electronic device is a smartphone.

11. A method of managing instant messaging in an electronic device, the method comprising:
detecting a first touch gesture through a touch screen;
producing a projected virtual keyboard by a virtual keyboard projector in response to the first touch gesture;
obtaining a first input content through the projected virtual keyboard;
transmitting the first input content to a first remote electronic device in communication with the electronic device; receiving a first messaging content from the first remove device;
detecting a second touch gesture through the touch screen; and
producing a first projected display and presenting the first messaging content in the first projected display by a first content projector in response to the second touch gesture.

12. The method of claim 11, further comprising:
obtaining a second input content through the projected virtual keyboard;
transmitting the second input content to a second remote electronic device in communication with the electronic device; and
receiving a second messaging content from the second remote device.

13. The method of claim 12, further comprising:
detecting a third touch gesture through the touch screen; and
producing a second projected display and presenting the second messaging content in the second projected display by a second content projector in response to a third touch gesture.

14. The method of claim 13, further comprising projecting the projected virtual keyboard, the first projected display, and the second projected display on different sides of the electronic device.

15. The method of claim 14, further comprising projecting the projected virtual keyboard on a longwise side of the electronic device, the first projected display on a first widthwise side of the electronic device, and the second projected display on a second widthwise side of the electronic device.

16. The method of claim 15, wherein the first widthwise side is opposite to the second widthwise side.

17. The method of claim 16, wherein the first touch gesture comprises a touch input moving along a substantially straight path towards the length side of the electronic device.

18. The method of claim 17, wherein the second touch gesture comprises a touch input moving along a substantially straight path towards the first widthwise side of the electronic device.

19. The method of claim 18, wherein the third touch gesture comprises a touch input moving along a substantially straight path towards the second widthwise side of the electronic device.
